(19) United States
(12) Patent Application Publication
(10) Pub. No.: US 2006/0092804 A1
(43) Pub. Date: May 4, 2006

(54) Digital data reproducing apparatus and method

(76) Inventors: Koichi Otake, Yokohama-shi (JP); Hideyuki Yamakawa, Kawasaki-shi (JP); Yukiyasu Tatsuzawa, Yokohama-shi (JP); Hiroyuki Moro, Fussa-shi (JP); Toshihiko Kaneshige, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/260,205

(22) Filed: Oct. 28, 2005

(30) Foreign Application Priority Data
Oct. 29, 2004 (JP) 2004-315891

(51) Int. Cl. G11B 20/10

(52) U.S. Cl. 369/59.22

(57) ABSTRACT

A signal processing circuit on a stage previous to a maximum likelihood decoder is more stably automatically controlled to have an optimum characteristic. A pre-equalizer, an offset control unit, an asymmetry control unit, an amplitude control unit, an analog digital converter, an adaptive equalizer, and a maximum likelihood decoder are sequentially arranged. A frequency control device and a phase control device are arranged. A sequencer feeds back error information obtained by the maximum likelihood decoder to any two of the offset control unit, the asymmetry control unit, the amplitude control unit, the analog digital converter, and the adaptive equalizer when at least the frequency control and phase control are set in predetermined control ranges, respectively.

### CROSS-REFERENCE TO RELATED APPLICATIONS

This application is based upon and claims the benefit of priority from prior Japanese Patent Application No. 2004-315891, filed Oct. 29, 2004, the entire contents of which are incorporated herein by reference.

### BACKGROUND OF THE INVENTION

1. Field of the Invention

The present invention relates to a digital data reproducing apparatus and method which reproduces data from a high-density optical disk or the like included in information recording media.

2. Description of the Related Art

In recent years, as a method of reproducing data from an optical disk or the like having a higher density, a partial response maximum likelihood (PRML) signal processing scheme having a partial response process and a maximum likelihood decoding process is examined.

When this scheme is employed, a reproducing procedure is as follows. That is, recording pits on an optical disk are read through an optical pickup. A read reproduction signal is sent to a preamplifier and subjected to a process such as signal amplification or the like and the subjected to previous waveform equalization by a pre-equalizer. The waveform-equalized signal is adjusted at a DC level by an offset control circuit and adjusted in signal amplitude by an amplitude control unit. An input signal level value is converted into a digital value by an analog-digital converter (ADC). A sampling clock of the ADC is supplied from a timing recovery unit. In a frequency detection unit, a clock frequency of the reproduction signal is detected, and frequency information is provided to a timing recovery unit.

The AD-converted reproduction signal is PR-equalized by an adaptive equalizer and subjected to maximum likelihood decoding by a maximum likelihood decoder on the basis of a predetermined PR class. A maximum-likelihood-decoded reproduction stream is reproduced as user data through subsequent synchronous demodulation, an error correction circuit, and the like. The following is examined. That is, depending on an error between an ideal signal obtained by the maximum likelihood decoder and an input signal, the offset control, the amplitude control, the adaptive equalization, the timing recovery unit, and the like are controlled, so that more precise control is performed.

### BRIEF SUMMARY OF THE INVENTION

In order to accurately obtain an error between an ideal signal obtained by a maximum likelihood decoder and an input signal, a maximum likelihood decoding result must be properly correct.

However, at the beginning of reproduction, a control values of signal processing units arranged on the previous stage of the maximum likelihood decoder is generally different from an optimum value. For this reason, the maximum likelihood decoding result may not properly correct. When the maximum likelihood decoding result is not properly correct, excessive time is required until the control values of the signal processing units arranged on a stage previous to the maximum likelihood decoding become the optimum value. In the worst case, the optimum value cannot be obtained forever.

In particular, in case of a removable disk such as an optical disk, a fluctuation of disk characteristics is large, and control initial values of the control circuits are considerably different from the optimum value. For this reason, the problem is more serious in the removable disk than in a hard disk or the like.

An object of the embodiments is to provide a digital reproduction apparatus and method which controls control sequences of a signal processing circuit arranged on a stage previous to maximum likelihood decoding such that the signal processing unit is more stably automatically controlled to have an optimum characteristic, which can properly obtain an error between an input signal obtained in a maximum likelihood decoding process and a reproduced signal in consequence, and which can reliably and quickly obtain a stable operation.

In order to achieve the above-described object, according to one aspect of the present invention, there is provided a digital data reproducing apparatus which processes a reproduction signal from an information recording medium to reproduce digital data, comprising: a equalizer which equalizes a waveform of the reproduction signal; an offset control unit which adjusts a DC level of an output from the equalizer; an asymmetry control unit which corrects asymmetry of an output from the offset control unit; an amplitude control unit which controls an amplitude of an output from the asymmetry control unit; an analog-digital converter which converts an output from the amplitude control unit into digital data; an adaptive equalizer which adaptively equalizes an output from the analog-digital converter to give a desired partial response waveform to the output; a maximum likelihood decoder which decodes an output from the adaptive equalizer to obtain binary data and to also obtain error information between an input and an ideal signal; a frequency control device which monitors a frequency of an output from the analog-digital converter and controls a sampling signal frequency of the analog-digital converter such that the frequency of the output is a desired frequency; a phase control device which monitors a phase of the output from the analog-digital converter and controls a sampling signal phase of the analog-digital converter such that the phase of the output is a desired phase; and a sequence control unit which feeds back the error information obtained by the maximum likelihood decoder to at least one of the offset control unit, the asymmetry control unit, the amplitude control unit, and the adaptive equalizer when the outputs from at least the frequency control device and the phase control device reach predetermined control ranges, respectively.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of a digital data reproducing apparatus according to the present invention;

FIG. 2A is a state transition diagram of a sequencer shown to explain an operation of the digital data reproducing apparatus in FIG. 1;

FIG. 2B is a diagram for explaining a table showing control states of the sequencer;

FIG. 2C is a diagram for explaining condition determination process of the sequencer;

FIG. 3A is a state transition diagram of a sequencer shown to explain another operation of the digital data reproducing apparatus in FIG. 1;

FIG. 3B is a diagram of a table showing control states of the sequencer shown to explain the other operation;

FIG. 3C is a diagram for explaining a condition determination process of the sequencer shown to explain the other operation; and

FIG. 4 is a diagram for explaining operating functions of a sequencer 230 for explaining another embodiment of the present invention.

### DETAILED DESCRIPTION OF THE INVENTION

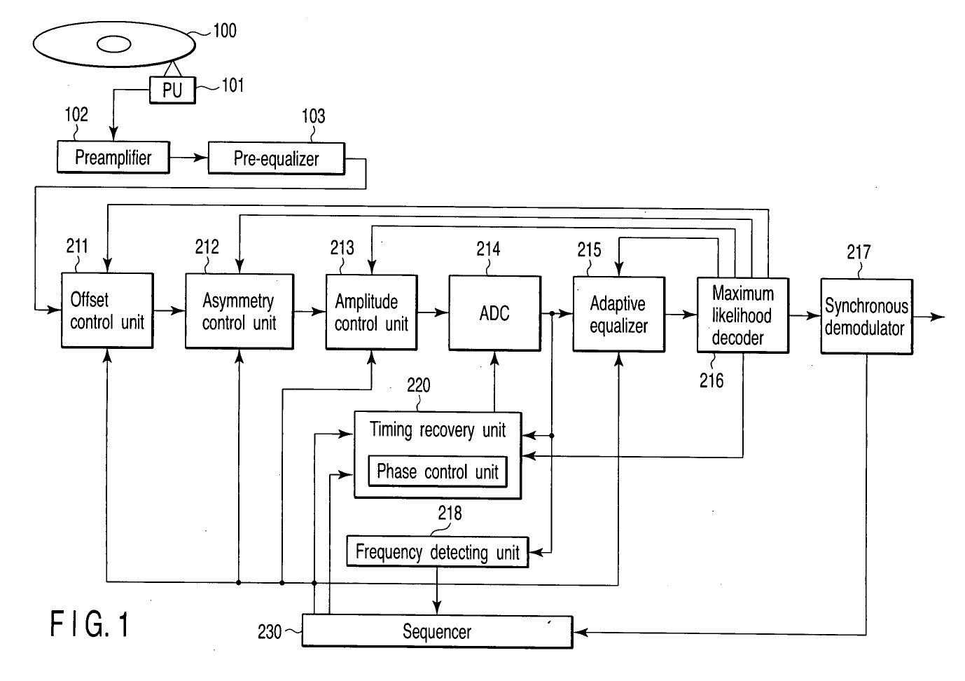

Embodiments of the present invention will be described below with reference to the accompanying drawings. FIG. 1 shows a configuration of a digital data reproducing apparatus according to an embodiment of the present invention. A read channel section of the apparatus is basically constituted by an optical disk 100, an optical pickup 101, a preamplifier 102, a pre-equalizer 103, an offset control unit 211, an asymmetry control unit 212, an amplitude control unit 213, an analog digital converter (ADC) 214, an adaptive equalizer 215, a maximum likelihood decoder 216, a timing recovery unit 220, a frequency detecting unit 218, a synchronous demodulator 217, and a sequencer 230.

Recording information recorded by recording pits on the optical disk 100 is read by the optical pickup 101 and converted into a voltage signal (reproduction signal). This reproduction signal is amplified by the preamplifier 102 and subsequently subjected to a previous waveform equalization process by the pre-equalizer 103.

An output from the pre-equalizer 103 is adjusted in a DC level in the offset control unit 211. The offset control unit 211 has a high gain mode, a low gain mode, and an ML mode. These modes are switched by a control signal from the sequencer 230 depending on situations. The high gain mode and the low gain mode are modes for adjusting a DC level by autonomous control on the basis of only an input signal. In the high gain mode, the DC level is rapidly adjusted from an initial state. However, in the low gain mode, the DC level moderately follows a change in DC level of the input signal. In the ML mode, DC level adjustment optimum for PRML is performed on the basis of an equalization error signal from the maximum likelihood decoder 216. However, in order to satisfy a desired capability in the ML mode, adaptive equalization is desirably ended.

The asymmetry control unit 212 adjusts the asymmetry of an output signal from the offset control unit 211. In the asymmetry control unit 212, when a signal waveform is vertically asymmetrical about a reference level, control is performed such that the asymmetry is corrected to be close to symmetry. The asymmetry control unit 212 also has a high gain mode, a low gain mode, and an ML mode. These modes are switched by a control signal from the sequencer 230 depending on states. The characteristics of the modes are the same as those in the offset control unit 211.

The amplitude control unit 213 adjusts amplitude of an output signal from the asymmetry control unit 212. The amplitude control unit 213 also has a high gain mode, a low gain mode, and an ML mode. These modes are switched by a control signal from the sequencer 230 depending on states. The characteristics of the modes are the same as those in the offset control unit 211.

The analog digital converter (ADC) 214 samples an output signal from the amplitude control unit 213 at a timing of a sampling clock to convert the output signal into a digital value.

The adaptive equalizer 215 adaptively equalizes an output signal from the analog digital converter 214 into a desired partial response (PR) waveform. Depending on a control signal from the sequencer 230, it is switched whether a tap coefficient of the adaptive equalizer 215 is learned or not. In order to obtain a desired equalized output, the learning is desirably started in a phase synchronous state.

The maximum likelihood decoder 216 performs maximum likelihood decoding to the adaptively equalized signal on the basis of a predetermined PR class. For example, maximum likelihood decoding is performed on the basis of a class PR (3443) to obtain binary data. In this case, an amount of error between an ideal level and the adaptively equalized signal is sent as an equalization error signal to the blocks of the offset control unit 211, the asymmetry control unit 212, the amplitude control unit 213, and the adaptive equalizer 215. In this case, a recording data string is recorded as 1116-bit data called a frame. The synchronous demodulator 217 detects a 24-bit binary data string (SYNC code) representing start positions of frames and generates 12-bit synchronous signals for a subsequent demodulation process. In the synchronous demodulator 217, a demodulation process for demodulating the 12-bit binary data into 8-bit reproduction data according to a predetermined rule.

The timing recovery unit 220 generates a sampling clock to synchronize the phase of the sampling clock with the phase of the reproduction signal clock. The timing recovery unit 220 includes a phase control unit. Mode switching is performed by a control signal from the sequencer 230. As the modes, a high gain mode in which the phase of an analog-digital converted signal and the phase of the sampling clock are compared with each other to feed back a phase error to a sampling clock generating unit and an ML mode in which phase comparison is performed on the basis of the maximum likelihood decoding result and the equalization error signal to perform phase feedback are switched to each other. In order to satisfy a desired capability in the ML mode, adaptive equalization is desirably ended. The timing recovery unit 220 includes a function of controlling a frequency of the sampling clock on the basis of a frequency control signal to adjust the frequency to a range in which phase pulling can be performed.

The frequency detecting unit 218 detects a frequency difference between the sampling clock and the reproduction signal clock on the basis of an ADC signal. In detection of a frequency, a frequency detection signal and a frequency error signal are output.

The synchronous demodulator 217 detects a synchronous signal on the basis of an maximum-likelihood-decoded output from the maximum likelihood decoder 216. When the synchronous signals are continuously detected at predetermined intervals, the synchronous demodulator 217 generates a phase synchronous detection signal. The synchronous demodulator 217 supplies a demodulated output to an error correction circuit or the like (not shown) of the next stage.

The sequencer 230 controls operations of blocks of offset control, asymmetry control, amplitude control, timing recovery, and an adaptive equalizer on the basis of a frequency detection signal, a frequency error signal, and a phase synchronous detection signal.

A frequency control signal of a sampling clock is generated on the basis of a frequency detection signal and a frequency error signal. When frequency control is in an ON state, the frequency control signal is generated on the basis of the frequency error signal each time the frequency detection signal is generated to increase and decrease the sampling clock frequency. In a frequency pulling state, phase pulling is stopped. After the phases are synchronized, the frequency pulling is stopped.

The timing recovery unit 220 includes a phase lock loop (PLL) circuit using a digital voltage control oscillator. An output (sampling clock) from the oscillator is designed to achieve a phase lock state with an external reproduction clock.

Control operations of the blocks performed by the sequencer will be described below.

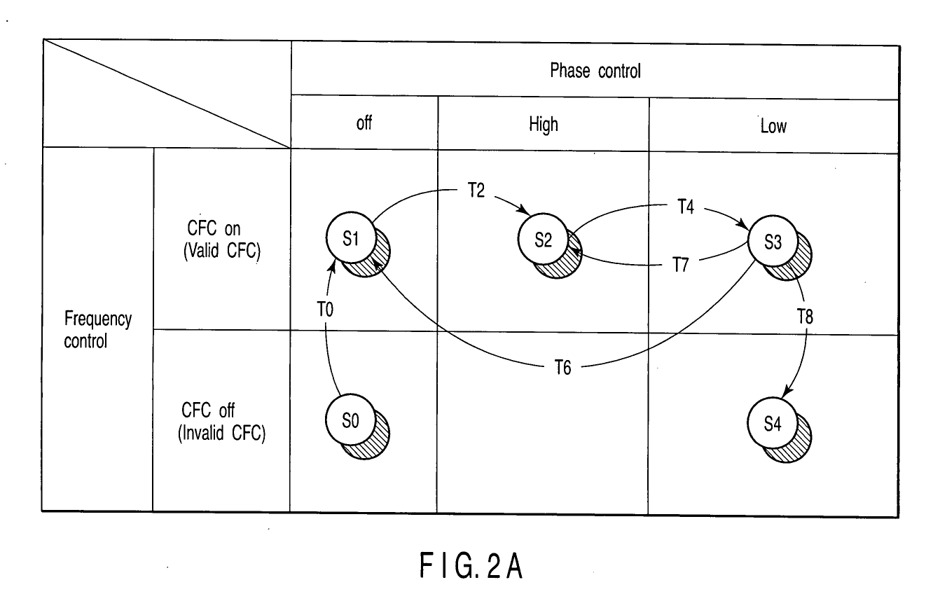

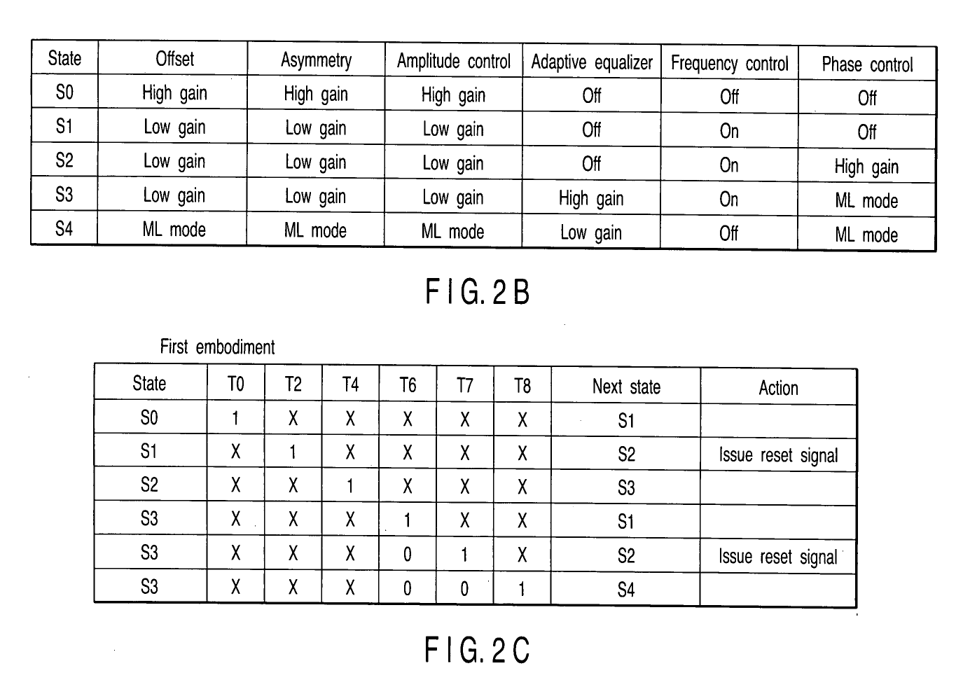

FIG. 2A is a state transition diagram of the sequencer 230. FIG. 2B is a diagram of a control state transition table of the blocks obtained by the sequencer 230 shown in FIG. 1. FIG. 2C shows condition determination of the sequencer 230 and destinations for the next state in a table as a whole.

In FIG. 2A, reference symbols S0 to S5 denote states (0 to 4 in FIG. 2B) of the sequencer. Reference symbols T0 to T8 denote transition conditions between the states.

Symbol S0 denotes a state in which the degrees of offset, asymmetry, and amplitude control are adjusted such that frequency control can be performed, symbol S1 denotes a state in which the degree of frequency control is adjusted such that phase control can be performed, symbol S2 denotes a state in which phase pulling is performed, symbol S3 denotes a state in which adaptive equalization is started to wait for determination of phase synchronization, and symbol S4 denotes a stationary lead state.

After a power supply is turned on, or before the start of reproduction of an optical disk, the state of the sequencer is initialized to S0. In the period of S0, as shown in FIG. 2B, the offset control unit 211, the asymmetry control unit 212, and the amplitude control unit 213 are set in the high gain modes, and the adaptive equalizer 215, frequency control (CFC), and phase control are set in off-states. When convergences of the offset, the asymmetry, and amplitude control are detected, the condition T0 is established, and transition to the state S1 is performed. FIG. 2C shows that the next state is the state S1 when T0=1 is satisfied in the state S0. As in the conditions T2, T4, T6, T7, and T8, a condition represented by X in the table may be either 1 or 0.

At this time, the offset control unit 211, the asymmetry control unit 212, and the amplitude control unit 213 are set in the low gain modes, and the frequency control (CFC) is set in an on-state.

When the frequency error is a set threshold value or less, the condition T2 is established, transition to the state S2 is performed. At this time, phase control is set in a high gain mode. Upon completion of phase pulling, the condition T4 is established, and transition to the state S3 is performed.

At this time, the adaptive equalizer 215 is set in the high gain mode, and the phase control is set in the ML mode. In this case, when it is detected that stationary read can be performed, the condition T8 is established, transition to the state S4 is performed.

However, when it is not detected for a predetermined period that the stationary read can be performed, the condition T7 is established, and transition to the state S2 is performed. When the frequency control is not sufficient, phase pulling may be unsuccessful. In this case, a frequency control signal is generated to finely adjust the frequency, the operation is restarted from the phase pulling in the state S2. This process is repeated until it is detected that stationary read can be performed. Transition to the state S1 is temporarily completely performed, and the operation may be restarted from frequency pulling control.

Then, when it is detected that the stationary read can be performed, the condition T8 is established, and transition to the state S4 is performed. At this time, the offset and asymmetry are set in the ML mode, the adaptive equalizer is set in the low gain mode, and the frequency control is set in the off-state.

The state in which the stationary read can be performed in the condition T8 means that phase synchronization and adaptive equalization are sufficiently successful to make it possible to read a reproduction signal with a capability of a predetermined level or higher. As methods for detecting the state, various methods can be applied. In this case, it is determined that synchronous signals are continuously detected at predetermined intervals in synchronous demodulation. However, this method is not always used.

When a frequency error exceeds a predetermined value in the state S3, the condition T6 is established, and the operation is restarted from the state S1.

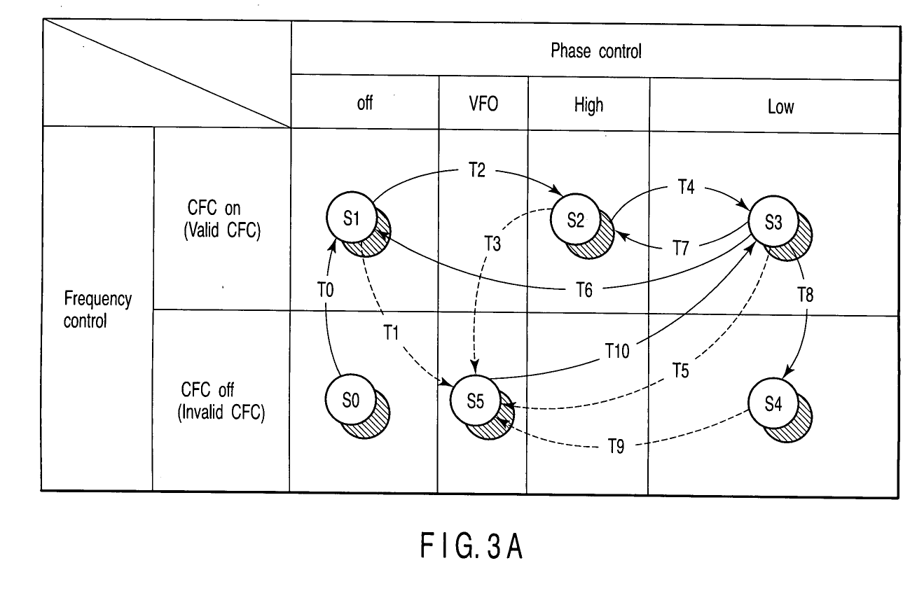

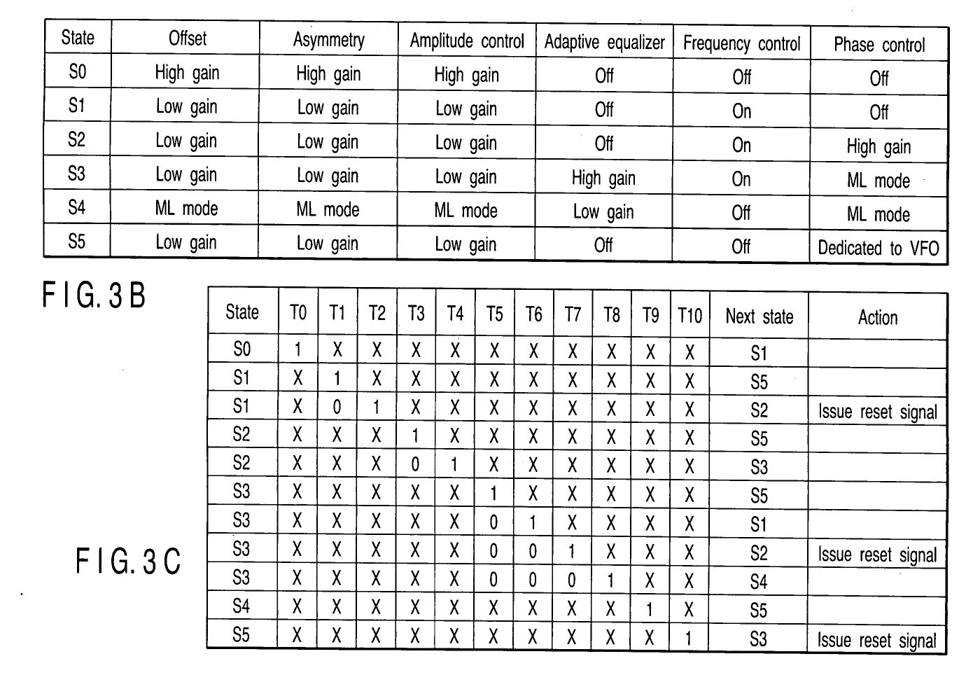

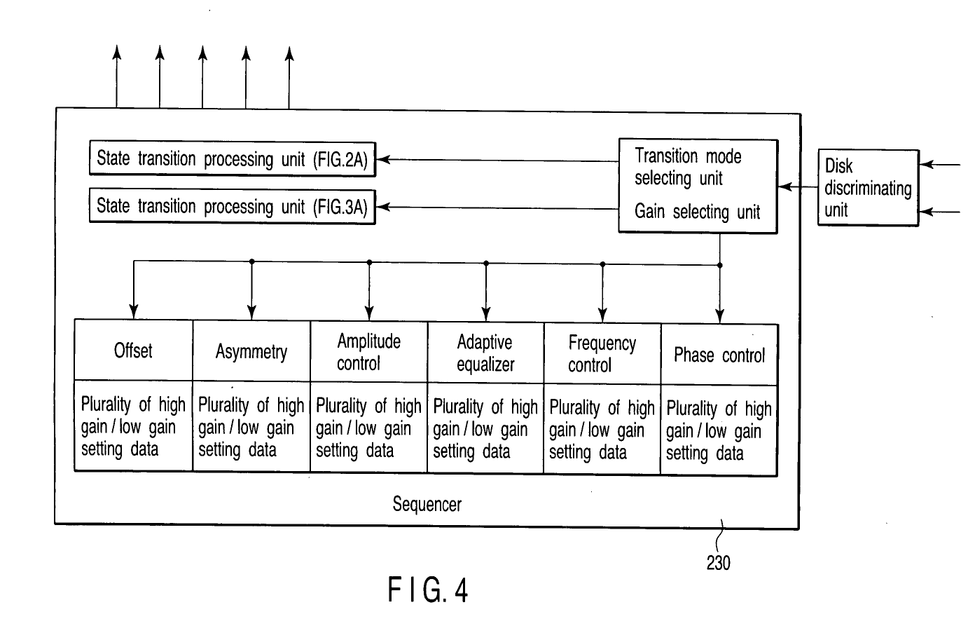

The present invention is not limited to the above embodiment. FIGS. 3A and 3B are a state transition diagram of a sequencer according to another embodiment and a diagram of a state transition table of the sequencer, respectively. In FIG. 3A, reference symbols S0 to S5 denote states of the sequencer, and reference symbols T0 to T10 denote transition conditions between the states. FIG. 3B is a diagram of a state transition table of blocks obtained by the sequencer 230 shown in FIG. 1. FIG. 3C shows condition determination of the sequencer 230 and destinations for the next state in a table as a whole.

FIG. 2A is different from FIG. 3A in that the state S5 is added. The addition of the state S5 can realize a high-speed access operation on a disk having a VFO region. The state S5 represents a state in which high-speed pulling using a VFO having a predetermined frequency and recorded in the VFO region is performed.

On a random-readable/writable disk, in many cases, a signal called a VFO and having a predetermined frequency is written at the start of each writing to have a predetermined length. In reproduction, frequency pulling and phase pulling are performed by VFO regions to make it possible to perform high-speed access.

Transitions of the states S0 to S4 are performed in the same manner as that in the embodiment in FIG. 2A.

After a power supply is turned on, a state of the sequencer is initialized to the state S0. In the period of the state S0, as shown in FIG. 3B, an offset control unit 211, an asymmetry control unit 212, and an amplitude control unit 213 are set in high gain modes, and an adaptive equalizer 215 and frequency control (CFC), and phase control are set in off-states. When convergences of offset, asymmetry, and amplitude control are detected, the condition T0 is established, and transition to the state S1 is performed. FIG. 3C shows that the next state is the state S1 when T0=1 is satisfied in the state S0. When there is a transition from a certain state to a plurality of states in the table, the states can be discriminated from each other by combinations of values (1 and 0) of the conditions. For example, a transition from the state S3 to the state S4 is performed, the conditions T5, T6, T7, and T8 have, e.g., values 0, 0, 0, and 1, respectively. As methods for expressing data of conditions T, various methods can be used. For example, the number of bits of each data is set as 4, and the data is expressed by the bit content.

In the states S1 to S4, when a VFO region is detected, the condition T1, T3, T5, or T9 is established, transition to the state S5 is performed.

In the period of the state S5, the offset control unit 211, the asymmetry control unit 212, the amplitude control unit 213 are set in the low gain modes, the adaptive equalizer 215 and the frequency control are set in off-states, and the phase control is dedicated to VFO (STATE 5 in FIG. 3B).

Upon completion of the phase pulling, the condition T10 is established, and transition to the state S3 is performed. At this time, the adaptive equalizer 215 is set in the high gain mode, and the phase control is set in the ML mode. In this case, when it is not detected that stationary read can be performed, as in the case in FIG. 2A, the operation is restarted from the state S2 or S3.

The present invention is not limited to the above embodiment. The sequencer 230 is designed such that the transition conditions T0 to T10 can be arbitrary set to be valid/invalid, and the state transitions in FIGS. 2A and 2B and FIGS. 3A and 3B can be realized by one sequencer. A disk to be reproduced is identified by using identification information or the like written on the disk to make it possible to select an optimum state transition diagram. Values of control signals of the blocks in the states are designed to be arbitrarily selected to make it possible to realize optimum sequence for various disks.

FIG. 4 simply shows functions in the sequencer 230. For example, depending on the types of disks, state transitions may be designed to be arbitrarily switched to the modes shown in FIG. 2A and the modes shown in FIG. 3A. Various gains of blocks to be controlled may be prepared to make it possible to arbitrarily select the gains. For this purpose, a transition mode selecting unit and a gain selecting unit are arranged. The transition mode selecting unit and the gain selecting unit may automatically switch the transition modes and gain setting data according to disk discrimination result. With respect to disk discrimination, a disk may be automatically discriminated by the apparatus itself, or a user may forcibly give discrimination information.

In the above explanation, the frequency control is subjected to an ON/OFF operation. However, the frequency control may include a high gain operation state and a low gain operation state.

The invention is not limited to the above embodiments. The present invention can be embodied by modifying its constituent elements in an execution phase without departing from the spirit and scope of the invention. Furthermore, various inventions can be achieved by appropriate combinations of the plurality of constituent elements disclosed in the embodiments. For example, several constituent elements may be deleted from all the constituent elements described in the embodiments. In addition, the constituent elements included in the different embodiments may be appropriately combined to each other.

With the above means, a maximum likelihood decoding process is always performed in an optimal environment and an optimal condition, and stable reproduction data can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital data reproducing apparatus which processes a reproduction signal from an information recording medium to reproduce digital data, comprising:
a pre-equalizer which equalizes a waveform of the reproduction signal;
an offset control unit which adjusts a DC level of an output from the pre-equalizer;
an asymmetry control unit which corrects asymmetry of an output from the offset control unit;
an amplitude control unit which controls an amplitude of an output from the asymmetry control unit;
an analog-digital converter which converts an output from the amplitude control unit into digital data;
an adaptive equalizer which adaptively equalizes an output from the analog-digital converter to give a desired partial response waveform to the output;
a maximum likelihood decoder which decodes an output from the adaptive equalizer to obtain binary data and to also obtain error information between an input and an ideal signal;
a frequency control device which monitors a frequency of an output from the analog-digital converter and controls a sampling signal frequency of the analog-digital converter such that the frequency of the output is a desired frequency;
a phase control device which monitors a phase of the output from the analog-digital converter and controls a sampling signal phase of the analog-digital converter such that the phase of the output is a desired phase; and
a sequencer which keeps a mode (ML mode) in which the error information obtained by the maximum likelihood decoder is fed back in an off-state to the offset control unit, the asymmetry control unit, the amplitude control unit, and the adaptive equalizer until the outputs from at least the frequency control device and the phase control device are set in predetermined control ranges, respectively, and turns on the ML mode to at least one of the offset control unit, the asymmetry control unit, the amplitude control unit, and the adaptive equalizer when the outputs reach the predetermined control ranges.

2. The digital data reproducing apparatus according to claim 1, wherein
the sequencer has means for performing a state transition process and for, before reproduction of recording information of the information recording medium is started, depending on a predetermined condition,
switching each of modes of the offset control unit, the asymmetry control unit, the amplitude control unit, the adaptive equalizer, the frequency control device, and the phase control device to at least a high gain mode and a low gain mode to perform state transition.

3. The digital data reproducing apparatus according to claim 2, wherein
the means for switching each of the modes of six blocks of the offset control unit, the asymmetry control unit, the amplitude control unit, the adaptive equalizer, the frequency control device, and the phase control device to at least the high gain mode and the low gain mode to perform state transition, performs:
transition to, as a state S0, a state in which the six blocks are set in a high gain mode, a high gain mode, a high gain mode, an off-state, an off-state, and an off-state, respectively to adjust the degrees of offset, asymmetry, and amplitude control such that frequency control can be performed;
transition to, as a state S1, a state in which the six blocks are set in a low gain mode, a low gain mode, a low gain mode, an off-state, an on-state, and an off-state, respectively to adjust the degrees of frequency control such that phase control can be performed;
transition to, as a state S2, a state in which the six blocks are set in a low gain mode, a low gain mode, a low gain mode, an off-state, an on-state, and a high gain mode, respectively to perform phase pulling;
transition to, as a state S3, a state in which the six blocks are set in a low gain mode, a low gain mode, a low gain mode, a high gain mode, an on-state, and an ML mode, respectively to start adaptive equalization and wait for determination of phase synchronization; and
transition to, as a state S4, a state in which the six blocks are set in an ML mode, an ML mode, an ML mode, a low gain mode, an off-state, and an ML mode, respectively to set a stationary read state.

4. The digital data reproducing apparatus according to claim 3, wherein the means further has, as a state S5, a state in which the six blocks are set in a low gain mode, a low gain mode, a low gain mode, an off-state, and an off-state, and the one dedicated to a VFO to read a signal having a predetermined frequency and recorded on a VFO region and to perform phase matching on a track of the information recording medium.

5. The digital data reproducing apparatus according to claim 4, wherein the sequencer has selection means for selecting a case in which a state transition process is performed among the states S0 to S4 and a case in which a state transition process is performed among the states S0 to S5.

6. A digital data reproducing method for processing a reproduction signal from an information recording medium to reproduce digital data, wherein
by using a pre-equalizer which equalizes a waveform of the reproduction signal, an offset control unit which adjusts a DC level of an output from the pre-equalizer; an asymmetry control unit which corrects asymmetry of an output from the offset control unit, an amplitude control unit which controls an amplitude of an output from the asymmetry control unit, an analog-digital converter which converts an output from the amplitude control unit into digital data, an adaptive equalizer which adaptively equalizes an output from the analog-digital converter to give a desired partial response waveform to the output, a maximum likelihood decoder which decodes an output from the adaptive equalizer to obtain binary data and to also obtain error information between an input and an ideal signal, a frequency control device which monitors a frequency of the output from the analog-digital converter and controlling a sampling signal frequency of the analog-digital converter such that the frequency of the output is a desired frequency, and a phase control device which monitors a phase of the output from the analog-digital converter and controls a sampling signal phase of the analog-digital converter such that the phase of the output is a desired phase,
a mode (ML mode) in which the error information obtained by the maximum likelihood decoder is fed back is kept in an off-state to the offset control unit, the asymmetry control unit, the amplitude control unit, and the adaptive equalizer until the outputs from at least the frequency control device and the phase control device are set in predetermined control ranges, respectively, and the ML mode is turned on to at least one of the offset control unit, the asymmetry control unit, the amplitude control unit, and the adaptive equalizer when the outputs reach the predetermined control ranges.

7. The digital data reproducing method according to claim 6, wherein
a sequencer performs a state transition process and, before reproduction of recording information of the information recording medium is started, depending on a predetermined condition,
switches each of modes of the offset control unit, the asymmetry control unit, the amplitude control unit, the adaptive equalizer, the frequency control device, and the phase control device to at least a high gain mode and a low gain mode to perform state transition.

8. The digital data reproducing method according to claim 6, wherein
when each of the modes of six blocks of the offset control unit, the asymmetry control unit, the amplitude control unit, the adaptive equalizer, the frequency control device, and the phase control device is switched to at least the high gain mode and the low gain mode to perform state transition,
transition to, as a state S0, a state in which the six blocks are set in a high gain mode, a high gain mode, a high gain mode, an off-state, an off-state, and an off-state, respectively to adjust the degrees of offset, asymmetry, and amplitude control such that frequency control can be performed;
transition to, as a state S1, a state in which the six blocks are set in a low gain mode, a low gain mode, a low gain mode, an off-state, an on-state, and an off-state, respectively to adjust the degrees of frequency control such that phase control can be performed;
transition to, as a state S2, a state in which the six blocks are set in a low gain mode, a low gain mode, a low gain mode, an off-state, an on-state, and a high gain mode, respectively to perform phase pulling;
transition to, as a state S3, a state in which the six blocks are set in a low gain mode, a low gain mode, a low gain mode, a high gain mode, an on-state, and an ML mode, respectively to start adaptive equalization and wait for determination of phase synchronization; and
transition to, as a state S4, a state in which the six blocks are set in an ML mode, an ML mode, an ML mode, a low gain mode, an off-state, and an ML mode, respectively to set a stationary read state are performed.

9. The digital data reproducing method according to claim 6, further comprising, as a state S5, a state in which the six blocks are set in a low gain mode, a low gain mode, a low gain mode, an off-state, and an off-state, and the one dedicated to a VFO to read a signal having a predetermined frequency and recorded on a VFO region and to perform phase matching on a track of the information recording medium.

10. The digital data reproducing method according to claim 6, wherein
even though as the state S3, a state in which the sixth blocks are set in a low gain mode, a low gain mode, a low gain mode, a high gain mode, an on-state, and an ML mode, respectively to start adaptive equalization and to wait for phase synchronization is set,
when a state in which stationary read can be performed is not detected for a predetermined period, transition to the state S2 is performed, and the operation is restarted from phase pulling.

11. The digital data reproducing method according to claim 6, wherein
even though as the state S3, a state in which the sixth blocks are set in a low gain mode, a low gain mode, a low gain mode, a high gain mode, an on-state, and an ML mode, respectively to start adaptive equalization and to wait for phase synchronization is set,
when a state in which stationary read can be performed is not detected for a predetermined period, transition to the state S1 is performed, and the operation is restarted from frequency pulling.
